(19) United States
(12) Patent Application Publication
(10) Pub. No.: US 2010/0241410 A1
(43) Pub. Date: Sep. 23, 2010

(54) Relative and Absolute Error Models for Subterranean Wells

(75) Inventors: Graham A. McElhinney, Inverurie (GB); Herbert M. J. Illfelder, Houston, TX (US)

Correspondence Address: SMITH INTERNATIONAL INC.;Patent Services, 1310 Rankin Rd., HOUSTON, TX, 77073, US

(73) Assignee: SMITH INTERNATIONAL, INC., Houston, TX (US)

(21) Appl. No.: 12/725,578

(22) Filed: Mar. 17, 2010

Related U.S. Application Data
(60) Provisional application No. 61/160,870, filed on Mar. 17, 2009.

(51) Int. Cl. G06G 7/50; G01V 9/00; G06F 19/00

(52) U.S. Cl. 703/10; 702/6

(57) ABSTRACT

A relative error model is used to compute a relative uncertainty in the position of a first well with respect to a second well. This relative uncertainty may be computed in real time during drilling and may be used in making subsequent steering decisions during drilling. Moreover, an absolute uncertainty in the position of a first well may be obtained by combining an absolute uncertainty in the position of a second well and the relative uncertainty in the position of the first well with respect to the second well.

### RELATED APPLICATIONS

This application claims the benefit of U.S. Provisional Application Ser. No. 61/160,870 entitled Relative and Absolute Error Models for Subterranean Wells, filed Mar. 17, 2009.

### FIELD OF THE INVENTION

The present invention relates generally to drilling and surveying subterranean boreholes such as for use in oil and natural gas exploration. In particular, this invention relates to methods for generating relative and absolute error models for a well path and to methods of combining uncertainties from multiple wells to obtain an improved error model.

### BACKGROUND OF THE INVENTION

In conventional well drilling applications an error model is used to compute the uncertainty of the well path as a function of measured depth. Such error models define the uncertainty of the position of the well as a function of measured depth. In such models, the uncertainties associated with making and interpreting survey measurements (for example, inclination, azimuth, and measured depth) accumulate with increasing measured depth resulting in a cone of uncertainty about the well. Examples of prior art error models include those disclosed by Wolff and DeWardt (Journal of Petroleum Technology, December, 1981) and Williamson (SPE 67616, August, 2000). The Williamson model is commonly referred to in the art as the ISCWSA model. These prior art models may be referred to as “absolute” error models in that they relate to the absolute or geographic position of the well path. The prior art error models take into account systematic errors (uncertainties) within any particular survey run. These systematic errors are essentially random and indefinable within some range.

In well twinning operations a twin well (or drilling well) is positioned in close proximity to a target well (a previously existing well). The absolute uncertainty of each well is usually large compared to the requirements for well separation. Therefore, in contrast to the above, the position of the twin well is commonly referenced with respect to (relative to) the target well (at any measured depth the twin well may be said to be some distance and direction from the target well). Magnetic ranging is commonly used in well twinning applications. For example, Kuckes (U.S. Pat. No. 5,589,775) discloses an active ranging technique for well twinning. McElhinney (U.S. Pat. No. 6,985,814) discloses a passive ranging technique for well twinning.

Well twinning is commonly utilized in steam assisted gravity drainage (SAGD) applications. In a typical SAGD application, twin wells are drilled having horizontal sections on the order of 1 km or more in length that are vertically separated by a distance typically in the range from about 4 to about 20 meters. During production, steam is injected into the upper well (the injector) to heat the tar sand. The heated heavy oil contained in the tar sand and condensed steam are then recovered from the lower well (the producer). The success of such heavy oil recovery techniques is often dependent upon producing precisely positioned twin wells maintaining the predetermined relative spacing over the entire horizontal injection/production zone. The wells need to be accurately positioned both in the geology (in an absolute sense) and with respect to one another (in a relative sense) to achieve optimum production. Improper positioning (in both an absolute sense and a relative sense) may severely limit production, or even result in no production, from the lower well (the producer).

Despite the need for such accurate positioning of the twin well there is no known relative error model for well twinning operations. This makes it difficult to assess the likelihood of successful placement of the wells. Therefore there is a need in the art for an error model that defines the uncertainty in the position of a twin well with respect to a target well. A further complication is that the azimuth of the twin well is generally not directly measurable due to the magnetic interference of the target well but is rather determined using the target well. For regulatory and planning purposes, there is also a need in the art for an error model that defines the uncertainty in the absolute position of the twin well.

### SUMMARY OF THE INVENTION

Exemplary aspects of the present invention are intended to address the above described need for improved error models for downhole drilling operations including well twinning operations. One aspect of this invention includes a method for determining a relative error model to compute the uncertainty in the position of a twin well with respect to a target well (the uncertainty may be defined for example with respect to the distance and direction between the twin and target at any measured depth). This relative uncertainty may be advantageously computed in real time during drilling and therefore may be used in making subsequent steering decisions in drilling the twin well. In another aspect, the invention includes a method for determining an absolute uncertainty for a twin well. The method involves combining the above described relative uncertainty with a conventional absolute uncertainty for the target well to obtain an absolute uncertainty for the twin well.

Exemplary embodiments of the present invention provide several technical advantages over prior art methods. For example, the invention advantageously provides methods for obtaining both relative and absolute uncertainties for a twin well. Moreover, the relative uncertainty may be advantageously computed in real time during drilling and may therefore enable a drilling operator to visualize the relative position (or range of possible positions) between the twin and target wells. The use of a relative error model to obtain relative uncertainties can be advantageous since the cost of errors in the relative position between the two wells is likely to be asymmetric. For example, while the optimum separation for production may be about five meters, the effect of a four meter separation may be significantly disadvantageous (or even catastrophic) for proper recovery while the cost of a six meter separation may be relatively minor. A one meter uncertainty may result in the planned separation being increased. The use of the relative error model may therefore provide for improved planning and placement of the twin well with respect to the target well. The invention further advantageously provides a method for combining a relative uncertainty of a twin well with an absolute uncertainty of the target well to obtain an absolute uncertainty of the twin well.

In one aspect, the present invention includes a method for determining a relative uncertainty between a first location on a first well and a corresponding second location on a second well. Inter-well ranging data is acquired and processed via a processor to obtain a separation between the first and second locations. The processor further processes at least one of the obtained separation and the acquired ranging data to obtain the relative uncertainty between the first and second locations.

In another aspect, the present invention includes a method for determining an absolute uncertainty of at least one location on a well. An absolute uncertainty of a first location on a first well is acquired. A relative uncertainty of a second location on a second well with respect to the first location on the first well is computed. The second location is within sensory range of the first location. The absolute uncertainty of the first location on the first well is combined with the relative uncertainty of the second location on the second well obtain an absolute uncertainty of the second location on the second well.

In still another aspect, the present invention includes a method for determining an absolute uncertainty in a well path. Absolute uncertainties of at least a first location on a first well and at least a second location on a second well are acquired using an absolute error model. The first and second locations are within sensory range of one another. A relative uncertainty between the first location and the second location is computed using a relative error model. Modified parameters for the absolute error model are computed from the acquired absolute uncertainty of the first location and the computed relative uncertainty. Absolute uncertainties are computed at selected other locations on the second well using the modified parameters computed in (c).

In yet another aspect, the present invention includes a method for determining an absolute uncertainty of at least one location on a well path. First and second wells are drilled to within sensory range of one another. A separation between at least a first location on a first well and at least a second location on a second well is measured. A relative uncertainty in the separation computed. Absolute uncertainties of at least the first and second locations are computed using an absolute error model. The computed absolute uncertainty of the first location is combined with the computed relative uncertainty to obtain an alternative absolute uncertainty of the second location.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and the specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 depicts a prior art SAGD well twinning operation.

FIGS. 2A, 2B, and 2C depict an exemplary SAGD well twinning production target.

FIGS. 3A and 3B depict a two-dimensional ellipse of relative uncertainty in accordance with the present invention.

FIGS. 4A and 4B depict plan and sectional dimensions of the ellipse of relative uncertainty shown on FIGS. 3A and 3B.

FIGS. 5A and 5B depict sectional and plan views of a substantially horizontal section of a SAGD twinning operation.

FIG. 6 depicts a plot of relative uncertainty as a function of measured depth for the SAGD operation depicted on FIG. 5A.

FIGS. 7A and 7B depict one exemplary embodiment of an empirical relative error model in accordance with the present invention.

FIG. 8 depicts a plot of TVD uncertainty as a function of measured depth for the SAGD operation depicted on FIG. 5A.

FIG. 9 depicts a three dimensional ellipsoid of relative uncertainty in accordance with the present invention.

FIG. 10 depicts a plot of borehole inclination, borehole azimuth, and dogleg severity versus measured depth for a sidetracking operation.

FIGS. 11A, 11B, and 11C depict an exemplary well drilling operation in which aspects of the present invention may be utilized to obtain a reduced absolute uncertainty. The depicted example includes two well paths: a predominantly vertical pilot well and a J-shaped well having a predominantly horizontal section that is within sensory range of the pilot well.

FIG. 12 depicts a plot of TVD uncertainty versus measured depth for the example depicted on FIGS. 11A-11C.

FIGS. 13A, 13B, and 13C depict another exemplary well drilling operation in which aspects of the present invention may be utilized to obtain a reduced absolute uncertainty. The depicted example includes two well paths: a first J-shaped well and a second J-shaped well having a horizontal section that is drilled up the horizontal section of the first well.

FIG. 14 depicts a plot of TVD error as a function of the measured depth of the second J-shaped well for the example depicted on FIGS. 13A-13C.

FIG. 15 depicts a flowchart of one exemplary method embodiment in accordance with the present invention.

### DETAILED DESCRIPTION

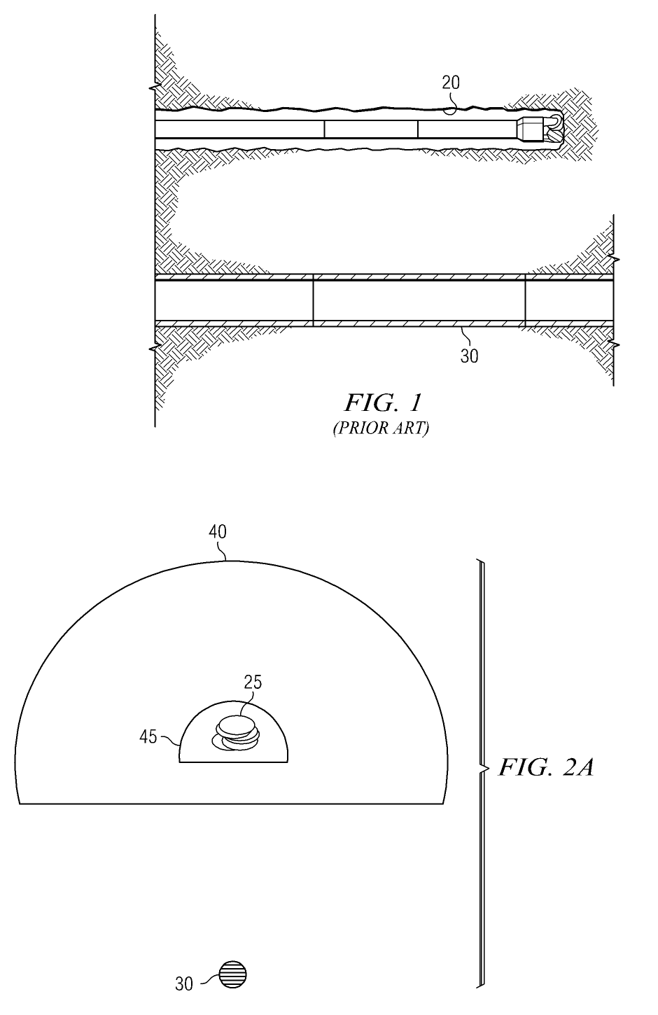

FIG. 1 schematically depicts one exemplary embodiment of a well twinning operation such as a SAGD twinning operation. Typical SAGD twinning operations require a second well 20 to be drilled a substantially fixed distance above (although not necessarily directly above) a horizontal portion of a first well 30. The second well is commonly referred to as the twin well or the injector. The second well may also be referred to herein as the drilling well. The first well is commonly referred to as the target well or the producer. In the exemplary embodiment shown, the producer 30 is drilled first, for example, using conventional directional drilling and MWD techniques. The target well 30 may then be cased, for example, using a plurality of pre-magnetized tubulars. Magnetic ranging measurements may be utilized to measure a distance between the twin 20 and target 30 wells and to guide subsequent drilling of the twin well 20. Commonly assigned U.S. Pat. Nos. 7,617,049 and 7,656,161 disclose magnetic ranging techniques that may be utilized in well twinning and SAGD operations. These patents are incorporated by reference in their entirety herein. Commonly assigned, co-pending U.S. patent application Ser. No. 12/150,997 (U.S. Publication 2008/0275648) is also fully incorporated by reference herein.

It will be understood that while certain aspects of the present invention are described herein with respect to an exemplary SAGD operation the invention is expressly not limited in these regards. In particular, the invention is not limited to SAGD or even generically to well twinning operations, but may be utilized to construct relative and absolute error models for substantially any operation where the relative positions of two or more wells may be measured with respect to one another. Moreover, the invention is not limited to the use of either passive or active magnetic ranging measurements. Substantially any suitable ranging methodology may be utilized.

As used herein the term “absolute error model” refers to an error model in which the entire well is referenced with respect to a fixed, singular (tie-in) point (e.g., the starting location of the well on the surface of the Earth). The error model is “absolute” in the sense that the measurements are typically used to compute an absolute geographic location of the well. Being tied to a single point, the errors in an absolute error model are cumulative and increase with measured depth. As used herein, the term is not necessarily intended to imply that the actual error is known with absolute certainty or that the well position is 100% certain to be within some computed volume. The Wolff and DeWardt and ISCWSA models are examples of conventional “absolute” error models. The application of an absolute error model to a particular well path results in an “absolute uncertainty” of that well path.

The term “relative error model” refers to an error model in which selected points on one well are referenced with respect to correspondingly distinct reference points on another well (e.g., corresponding least distance points between twin and target wells in a well twinning operation). Relative error is not cumulative and therefore generally does not increase continuously with measured depth. The application of a relative error model to a particular well path results in a “relative uncertainty” of at least one position in that well path relative at least one corresponding position on another well path (it will be appreciated that the absolute uncertainty of the twin and target wells can be ignored when determining the relative uncertainty).

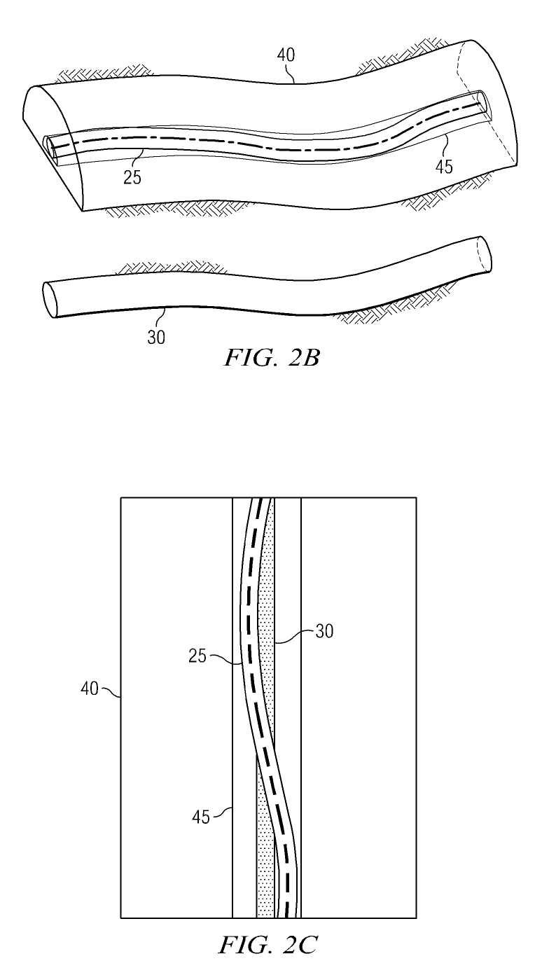

FIG. 2A depicts a cross-axial section through a hypothetical SAGD well twinning production target (placement of the injector 20 relative to the producer 30). As shown, the production target may include one or more targets, e.g., including (i) a tolerable production target 40 at which less than ideal production may be realized and (ii) an optimum production target 45 at which optimum production may be realized. These targets may vary from operation to operation and are depicted solely for the purpose of explaining the invention. As such, the invention is not limited in these regards. These targets follow the producer 30 at some predetermined distance as depicted on FIG. 2B. Changes in inclination and azimuth of the twin well 20 (FIG. 1) may be required to follow the path of the target well due to the variation in drilling path of the target well 30.

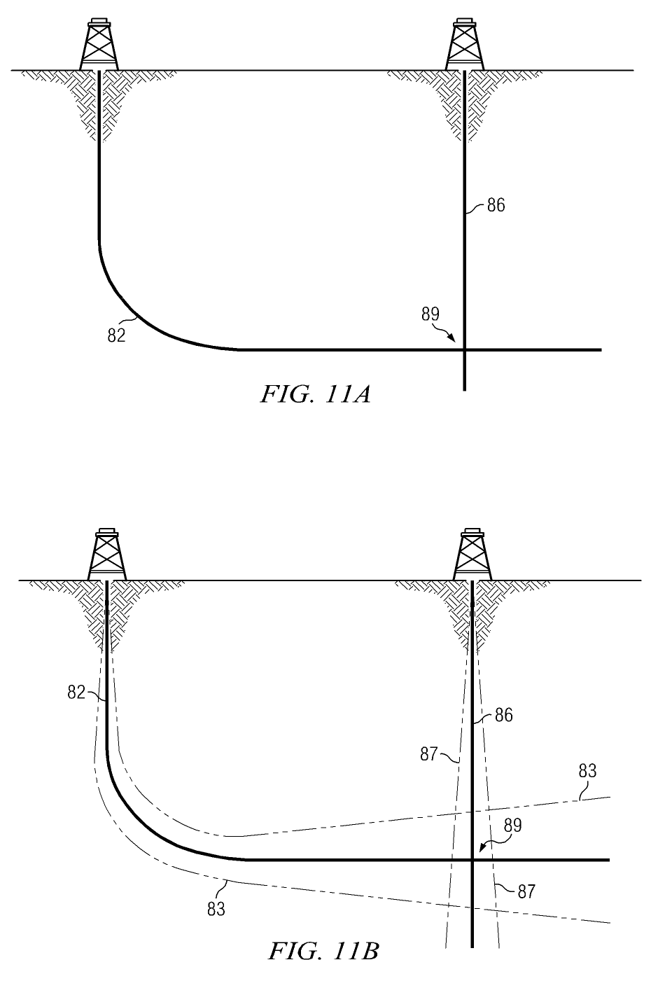

FIG. 2A further depicts an overlaying relative error model (relative uncertainty) in accordance with the present invention. In the exemplary embodiment shown, the uncertainty of the relative position between the twin and target wells (referred to herein as the relative uncertainty) is shown as a series of two-dimensional ellipses 25 which in combination define a locus of possible points through which the twin well passes. These relative error ellipses (or three dimensional ellipsoids as in FIG. 9) are sometimes referred to herein as “ellipses of uncertainty”. However, it will be understood that the relative error is not necessarily elliptical in shape. The terms ellipse and ellipsoid are used herein merely for the convenience of using similar terminology as is used in the industry (e.g., as in Wolff and DeWardt). The use of such similar language is not intended to be limiting, but rather to enable practitioners in the art to more readily appreciate the inventive models disclosed herein. Moreover, in certain embodiments of the invention, the relative error model of the twin well 20 is combined with an absolute error model of the target well 30. The resulting combined error model can also be said to include ellipses or ellipsoids of uncertainty in a manner that is similar to the prior art error models.

With continued reference to FIG. 2A, the changes in the size and location of the ellipses of uncertainty 25 show the relative change in position between the twin 20 and target 30 wells as a function of measured depth. Note, in this example, that these changes are minor and that the twin well remains largely in the optimum production target. This is further depicted on FIG. 2B, which shows the relative position of the twin well 20 with respect to the target well 30 as a function of measured depth. FIG. 2C shows a plan view of the production target with the overlaying relative uncertainty 25.

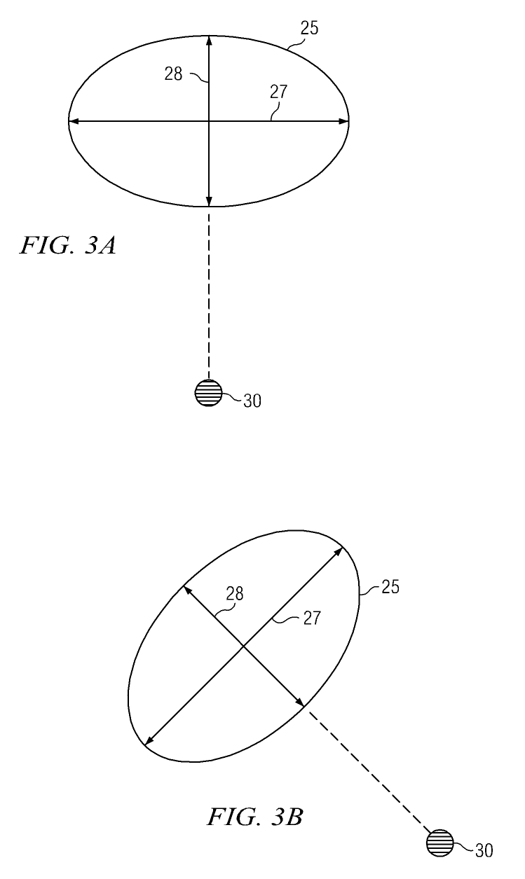

FIGS. 3A and 3B depict a two-dimensional ellipse of relative uncertainty 25 in more detail (again in circular cross section looking down the target well 30). In the exemplary embodiment depicted on FIG. 3A, the twin well is located directly above the target well 30. The ellipse of uncertainty 25 is derived from a distance uncertainty 28 and a tool face to target (TFTT) uncertainty 27. In FIG. 3B the twin well is located above and to the left of the target well 30. In this particular arrangement, the ellipse of uncertainty 25 is oriented at an angle, such that the TFTT uncertainty 27 is tangential and the distance uncertainty 28 is radial to the target well 30. Computation of distance and TFTT uncertainties is discussed in more detail below. It will be understood that FIGS. 3A and 3B are not drawn to scale and that the ellipse of uncertainty 25 is exaggerated in size for illustrative purposes. It will also be understood that the ellipses depicted on FIGS. 3A and 3B depict relative uncertainties.

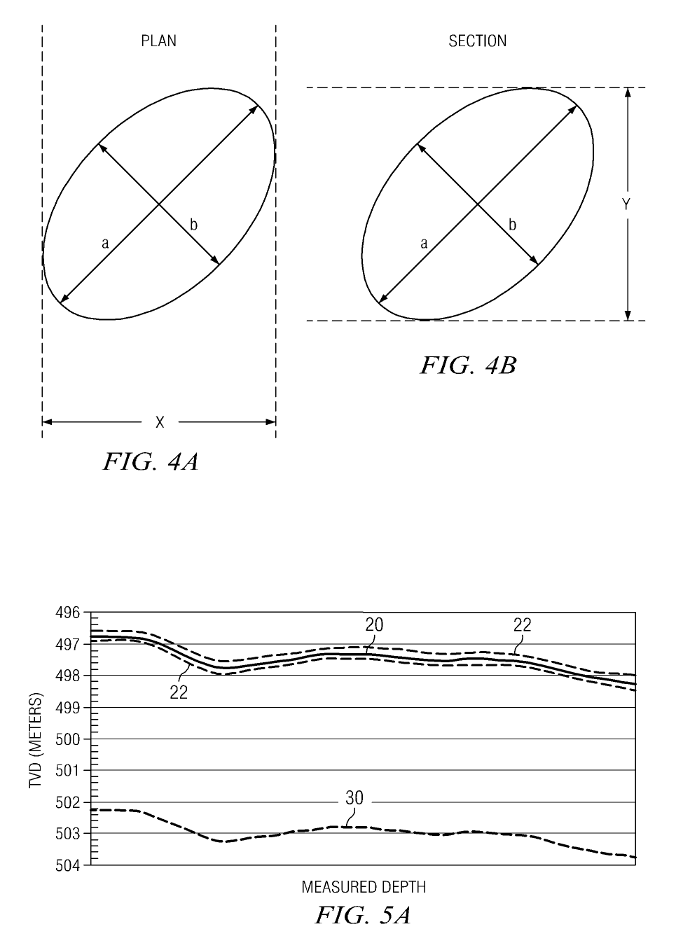

The ellipse of uncertainty 25 may also be represented with respect to a plan dimension, x, and a section dimension, y, as depicted on FIGS. 4A and 4B. The plan and section dimensions may then be utilized to depict the relative uncertainties in plan and sectional views. In the exemplary embodiment depicted, the plan dimension, x, and the section dimension, y, may be expressed mathematically, for example as follows:

x=b+|(a−b)·|cos TFTT∥ Equation 1

y=b+|(a−b)·|sin TFTT∥ Equation 2

Where a and b are depicted on FIGS. 4A and 4B and represent the TFTT uncertainty and the distance uncertainty respectively and | . . . | indicates the absolute value of a quantity. Those of ordinary skill in the art will readily be able to move back and forth between the borehole reference frame depicted on FIGS. 3A and 3B and the Earth's reference frame (as exemplified by plan and sectional views).

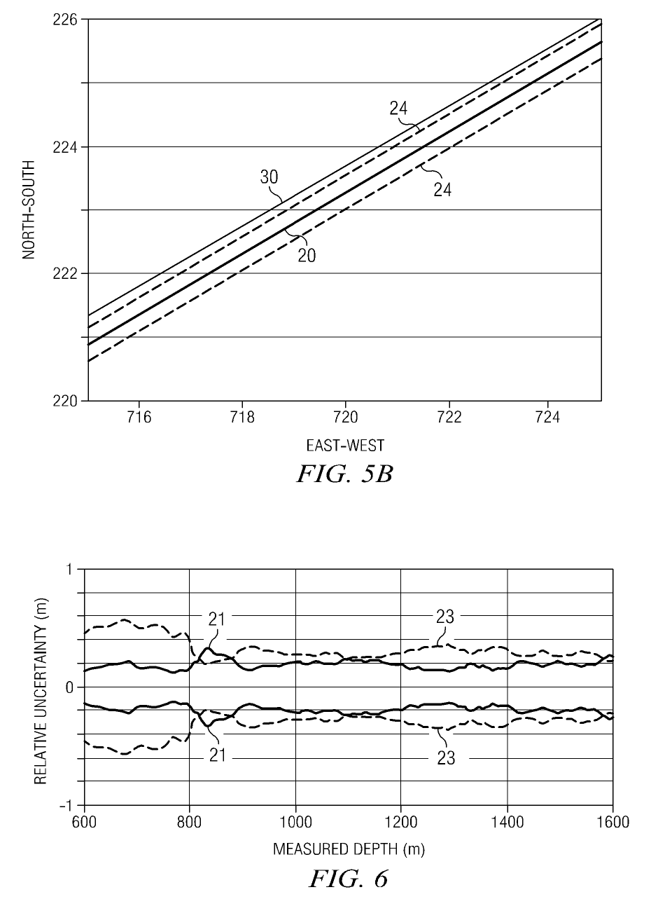

FIGS. 5A and 5B depict sectional and plan views of a substantially horizontal section of a SAGD twinning operation. The vertical and horizontal axes are in units of meters. The positions of the producer 30 and injector 20 are shown in each of the views. The relative positional uncertainty (derived from the relative error model) is also shown about the injector 20. In the sectional view (FIG. 5A), the relative uncertainty in total relative vertical depth (TVD) 22 at any particular measured depth is defined by the section dimension, y (Equation 2). In the depicted example, the upper uncertainty is given by the TVD of the twin well plus y, while the lower uncertainty is given by the TVD of the twin well minus y. Note, that in this example, the relative TVD uncertainty is at least an order of magnitude less than the vertical distance between the twin and target wells. As described in more detail below, the relative TVD uncertainty is also significantly less than the absolute TVD uncertainty of the target well.

FIG. 5B depicts a plan view of a portion of the sectional view depicted on FIG. 5A (only a portion is shown for clarity). The horizontal uncertainty at any particular measured depth is defined by the plan dimension, x (Equation 1). In the depicted example, the horizontal uncertainty 24 is given by plus or minus x, although the invention is not limited in this regard. In the exemplary embodiment shown, the twin well 20 is about 0.5 meters to the right of the target well 30 per specification.

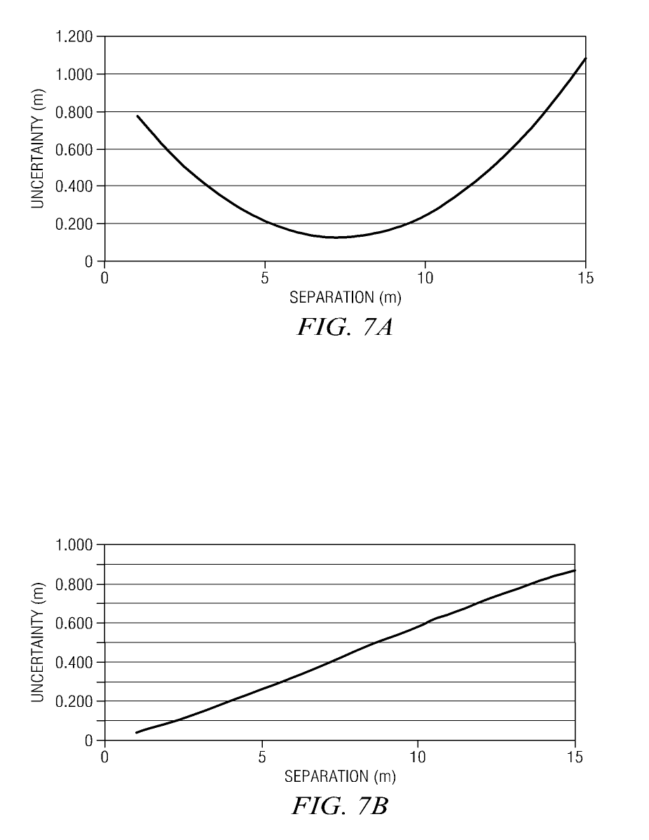

FIG. 6 depicts a plot of relative uncertainty as a function of measured depth in units of meters for the SAGD operation depicted on FIG. 5A. The relative uncertainty is expressed as a distance uncertainty 21 and a TFTT uncertainty 23. Note, that the magnitude of the relative uncertainties 21 and 23 both increase and decrease with increasing measured depth. As noted above and described in more detail below, the relative uncertainty is not cumulative, but rather tends to be a function of the instantaneous separation distance between the twin and target wells.

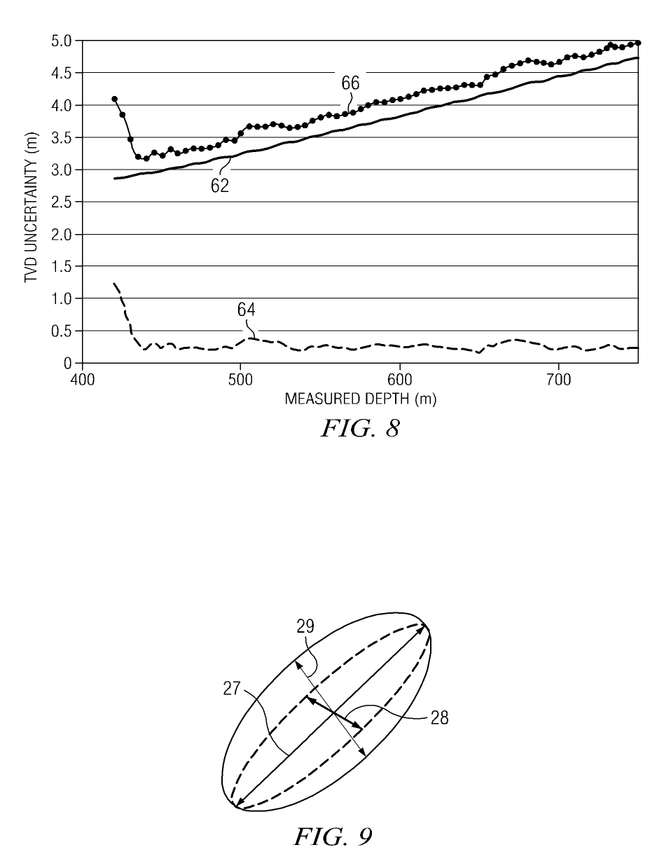

It will be appreciated that error models in accordance with the present invention may utilize errors (uncertainties) input from (or calculated based upon) substantially any source. These errors may include either or both theoretical and empirical observations. The errors may be based, for example, upon known sensor errors or known limits in sensor resolution. The invention is not limited in these regards. In the exemplary embodiments described above with respect to FIGS. 5A, 5B, and 6, the distance and TFTT uncertainties were obtained from an empirical model developed via surface measurements. It was found that both the distance uncertainty and the TFTT uncertainty were related to the relative distance between the twin and target wells. This exemplary empirical relative error model is depicted on FIGS. 7A and 7B.

Following one exemplary procedure, FIG. 7A depicts a plot of relative distance uncertainty (distance uncertainty 28 depicted on FIGS. 3A and 3B) as a function of the relative distance between the twin 20 and target 30 wells. As depicted, a minimum relative uncertainty is obtained at a relative distance (between the twin and target wells) of approximately 7 meters. As the relative distance between the twin and target wells decreases, the magnetic field profile about the target well tends to become less uniform due to the presence of the magnetized casing collars. In the exemplary embodiment depicted, this tends to result in increasing relative uncertainty with decreasing distance. As the relative distance increases beyond about 8 meters, the relative distance uncertainty also tends to increase due to a reduction in magnetic field strength. It will be appreciated that in the exemplary embodiment shown the system was designed so as to have minimum relative error at a relative distance of about 7 meters. The invention is of course not limited in these regards.

FIG. 7B depicts a corresponding plot of a relative positional uncertainty due to TFTT uncertainty (TFTT uncertainty 27 depicted on FIGS. 3A and 3B) as a function of the relative distance between the twin and target wells. In the exemplary embodiment depicted, the TFTT uncertainty increases with increasing relative distance between the twin and target wells. In this example, the angular uncertainty in the TFTT is relatively constant over the range of distances being observed, resulting in a tangential positional error that increases approximately linearly with distance.

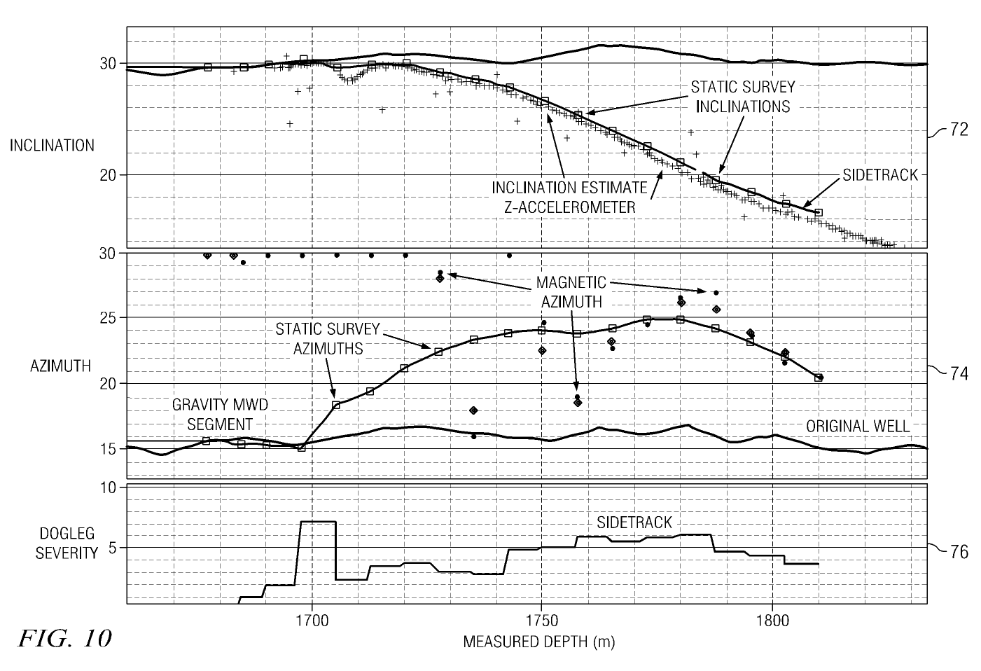

The invention may also be utilized to determine an absolute error model of the twin well. This may be accomplished by combining the conventional absolute uncertainties for the target well (e.g., obtained via the Wolff and DeWardt model) with the above described relative uncertainties for the twin well. FIG. 8 depicts a plot of vertical uncertainty (TVD uncertainty) as a function of measured depth for a portion of the SAGD operation described above. The plot depicts a conventional absolute uncertainty 62, a relative uncertainty 64 (which is described above with respect to FIGS. 3, 4, and 5), and a combined uncertainty 66. The conventional absolute uncertainty is an as-received uncertainty computed for the target well (e.g., via the conventional Wolff and DeWardt or ISCWSA methodologies). As is known to those of ordinary skill in the art, the absolute uncertainty increases with increasing measured depth as depicted. The envelop enclosing the series of ellipses (or ellipsoids for a three dimensional model) appears as a cone of constantly increasing radius and is therefore commonly referred to as a cone of uncertainty. In the exemplary embodiment shown, the combined uncertainty is obtained by combining the absolute uncertainty of the target well with the relative uncertainty of the twin well respect to the target well. The resultant combined uncertainty provides an absolute uncertainty for the twin well. As depicted on FIG. 8, the relative uncertainty between the twin and target wells is small (virtually insignificant) as compared to the absolute uncertainty of the target well. This is, of course, why relative positioning (e.g., via magnetic ranging) is used when drilling a twin well having tight tolerances.

It will be appreciated that the combined uncertainty depicted on FIG. 8 defines the absolute positional uncertainty of the twin well (FIG. 8 depicts TVD uncertainty). As is known to those of ordinary skill in the art, the conventional absolute error model defines the absolute uncertainty of the target well. The use of the combined error model of this invention may be advantageously utilized to compare the relative positions of first and second pairs of wells. For example, in SAGD operations it is desirable to space multiple well pairs (i.e., multiple pairs of injectors and producers) sufficiently close so as to maximize production but not so close so as to decrease the efficiency of said production.

With reference now to FIG. 9, a relative uncertainty may also be computed in three dimensions at each (or at selected) measurement points (survey stations). FIG. 9 depicts an ovaloid (or ellipsoid) of uncertainty defined by a distance uncertainty 28, a TFTT uncertainty 27, and a third dimension of uncertainty 29. The distance uncertainty and TFTT uncertainty may be estimated, for example, as described above. The third dimension of uncertainty may be related, for example, to a measured depth uncertainty, however, the invention is not limited in this regard.

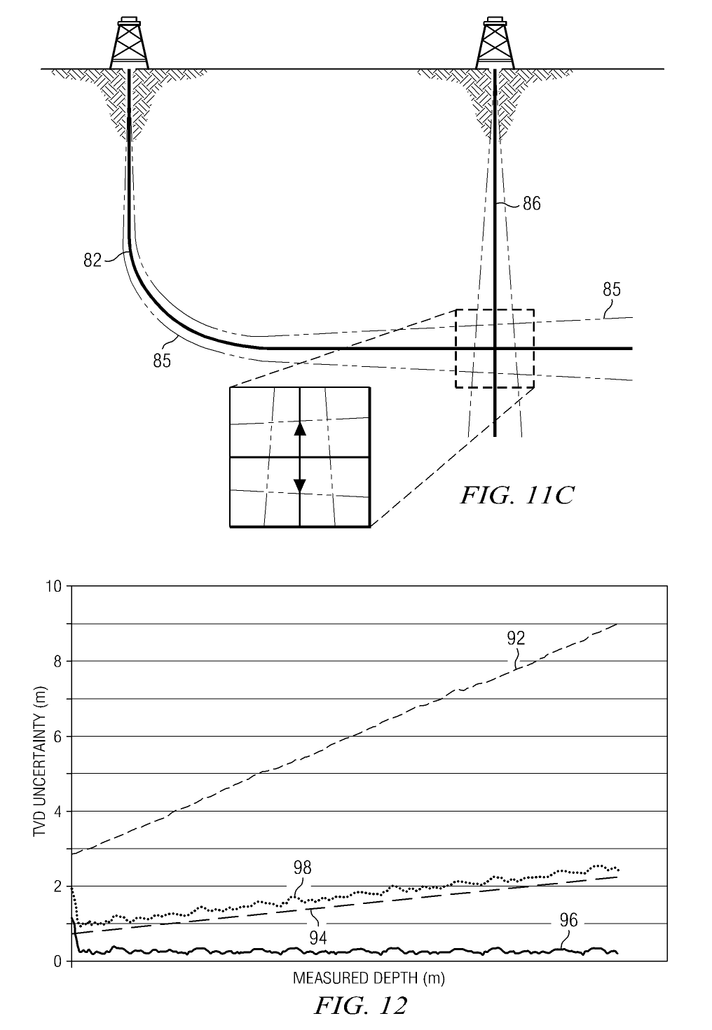

FIG. 10 depicts another aspect of the present invention. FIG. 10 shows a plot of borehole inclination 72, borehole azimuth 74, and dogleg severity 76 on the y-axis (the vertical axis) versus measured depth on the x-axis (the horizontal axis) for a sidetracking operation using Gravity MWD (Gravity MWD is described in more detail in commonly assigned U.S. Pat. No. 7,080,460). The original well is referred to as the first well. The sidetrack well is referred to as the second well. In the exemplary embodiment shown, information from the first and second wells is displayed as a function of measured depth of the second well. In this particular example, the second well decreases inclination (drops) and increases azimuth (turns to the right) with respect to the original (first) well. It will be understood that the survey data (inclination, azimuth, etc.) from the first well is plotted as a function of the measured depth of the second well. In this particular embodiment, the data at predetermined measured depths in the second well is compared with data from corresponding points on the first well. It will be understood that the measured depths on the first well are typically not the same as those on the second well (due to the difference in curvature, tortuosity, etc.). The corresponding points on the first well may be determined using a least distance calculation from the predetermined measured depths on the second well. The data of interest (inclination, azimuth, etc) is then plotted at the predetermined measured depth of the second well.

The resulting plot (as shown on FIG. 10) enables a meaningful comparison of the behavior of the second well at predetermined measured depths with corresponding points on the first well that are a least distance from those predetermined measured depths. It will be understood that the invention is not limited by the depicted embodiment. For example, substantially any number of wells can be calculated. Moreover, the data for the wells may also be plotted versus the measured depth of any of the wells. Normalized distances (depths) may also be utilized. Nor is the invention limited to measured depth. Other parameters may likewise be utilized.

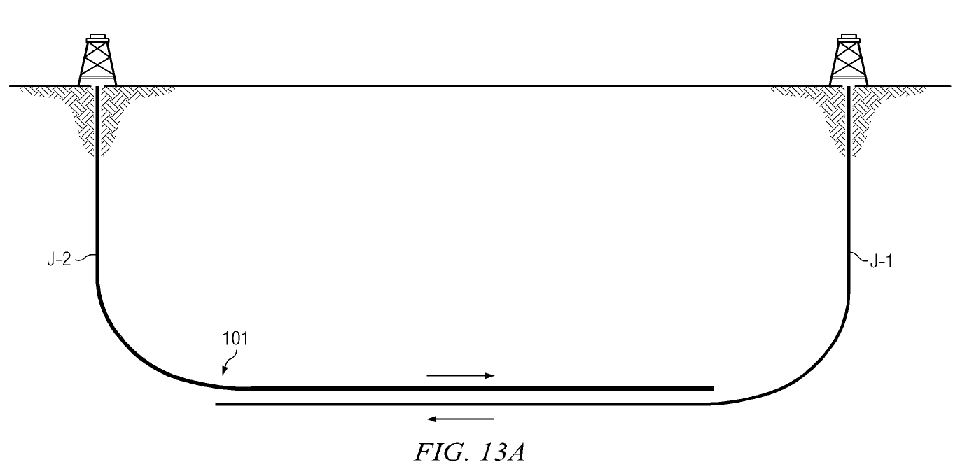

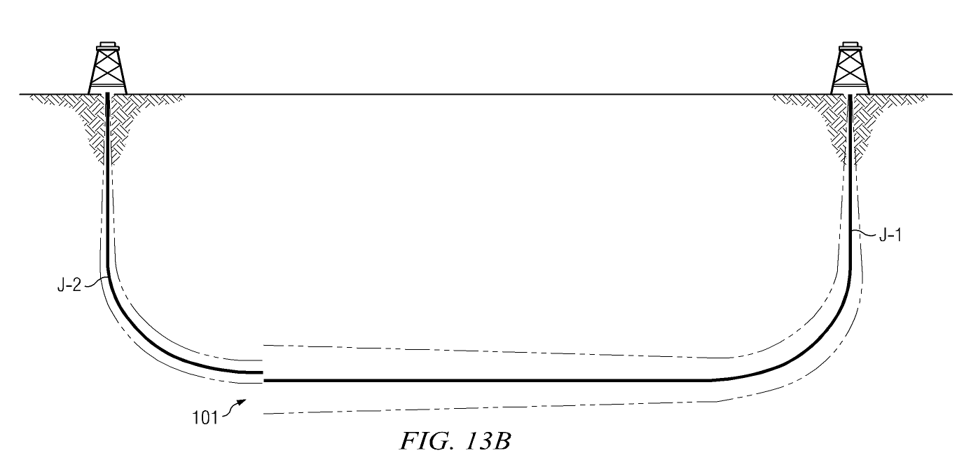

Another aspect of the invention is described with respect to FIGS. 11 and 12. FIG. 11A depicts first and second subterranean boreholes 82 and 86. The first well 82 is a conventional J-shaped well having vertical, dogleg, and horizontal sections. Such wells are commonly drilled in a number of oilfield applications including the aforementioned SAGD applications. The second well 86 is a vertical pilot well that intercepts or passes within sensory range (e.g., magnetic sensory range) of the J-shaped well 82. A point at which the two wells 82 and 86 are in sensory range of one another (e.g., at a point of closest approach) is referred to herein as an “intercept” 89 (the intercept is not typically a true intercept in the sense that the wells do not typically come into contact one another). It will be appreciated from the schematic depiction on FIG. 11A that the J-shaped well 82 has as a significantly greater measured depth at the intercept 89 than does the vertical pilot well 86.

FIG. 11B adds the depiction of the conventional absolute uncertainties 83 and 87 of the J-shaped well 82 and the pilot well 86, each of which represents a cone of uncertainty centered on the respective well path. These standard error models may be computed, for example, using conventional Wolff and DeWardt and/or ISCWSA methodologies. As described above (and as depicted), the resulting absolute uncertainties increase monotonically with increasing measured depth of the wells 82 and 86. As known to those of ordinary skill in the art, this results in a defined uncertainty (or volume of uncertainty) at any particular measured depth. Due to its smaller measured depth and less complicated well path, the pilot well 86 has a significantly lower absolute uncertainty 87 at the intercept 89 as compared with the absolute uncertainty 83 of the J-shaped well 82.

It will be understood based upon the foregoing discussion that the nominal position of the intercept 89 on the J-shaped well 82 may be determined using two distinct methodologies: (i) standard surveying of the J-shaped well 82 and (ii) standard surveying of the vertical pilot well 86 in combination with a measurement of the relative position of the J-shaped well 82 with respect to the pilot well 86 at the intercept 89. It will also be understood that the positional uncertainty will often be significantly less using the latter of these two methodologies. One aspect of the present invention is the realization that the absolute uncertainty of the pilot well 86 at the intercept 89 may be used to determine an absolute uncertainty of the J-shaped well 82 at the intercept 89. This can result in a significant reduction in the absolute uncertainty of the J-shaped well 82 at the intercept 89. Moreover, the new nominal position and absolute uncertainty of the J-shaped well 82 may be used to derive corrections to previously made survey measurements of the J-shaped well.

With reference now to FIG. 11C, the alternatively derived position, corrections, and/or absolute uncertainty (from the pilot well 86 to the J-shaped well 82 as described in the preceding paragraph) may be utilized to recalculate the absolute position and uncertainty of the J-shaped well 82 along its path retrospectively back up to the surface. The corrections may then be applied to additional drilling of the J-shaped well 82 as drilling continues past the vertical pilot well 86. The reduced uncertainty and enhanced confidence in the measurements result in an absolute error (uncertainty) that increases more slowly than would normally be expected with measured depth. The resultant combined absolute uncertainty 85 for the J-shaped well 82 tends to be significantly less than that obtained using conventional methodologies. It will be appreciated that the combined uncertainty may also be computed in substantially real-time during drilling. For example, in an operation in which the J-shaped well 82 intercepts the vertical pilot well 86 during drilling, the combined error model may be applied retrospectively to the surface at the time of intercept and forward in real-time as drilling progresses (after the intercept). The invention is not limited in these regards.

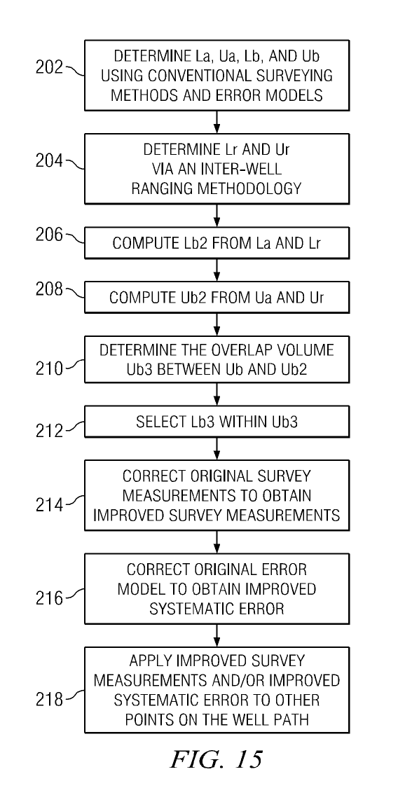

With continued reference to FIG. 11C, it will be understood that the uncertainty 87 of the pilot well 86 does not typically correspond dimensionally in a one-to-one fashion with the uncertainty 83 of the J-shaped well 82. For example if the pilot well is truly vertical (having a zero inclination at the intercept) and the J-shaped well is truly horizontal (having a 90 degree inclination at the intercept), then a measured depth error in the pilot well corresponds closely with an inclination error in the J-shaped well (this is discussed in more detail below with respect to FIG. 15). It will further be appreciated that FIGS. 11A-11C are not necessarily drawn to scale. In particular, J-shaped wells commonly have horizontal sections that are much longer than the corresponding vertical and doglegged sections (e.g., a horizontal section on the order of thousands of meters and a vertical section on the order of hundreds of meters). It will thus be further appreciated that the achievable improvement in absolute uncertainty tends to be underestimated in the schematic depicts shown on FIGS. 11A-11C.

FIG. 12 depicts a plot of TVD uncertainty versus measured depth for the example described above with respect to FIGS. 11A-11C. In this figure, the error in TVD is displayed, although it will be understood that errors in any dimension may alternatively be used and would tend to demonstrate an identical (or nearly identical) behavior. The conventional absolute uncertainty of J-shaped well 82 is plotted at 92 and the combined uncertainty (acquired using the methodology described above with respect to FIG. 11C) is plotted at 94. FIG. 12 again illustrates the significant reduction in uncertainty that can be achieved using a combined error model in accordance with aspects of the present invention.

With continued reference to FIG. 12, J-shaped wells (such as well 82 on FIG. 11A) are commonly twinned during SAGD operations. As described above, a relative uncertainty between a twin and a target well may be computed. This relative uncertainty is depicted at 96. The relative uncertainty depicted at 96 may be further combined with the combined uncertainty depicted at 94 (as described above) to obtain an absolute uncertainty of the hypothetical twin well (the twin well is not shown on FIGS. 11A-11C). This further combined uncertainty is depicted at 98. The resultant absolute uncertainties for both the twin and target wells (depicted at 98 and 94) tend to be significantly less than the absolute uncertainties obtained using conventional methodologies (depicted at 92).

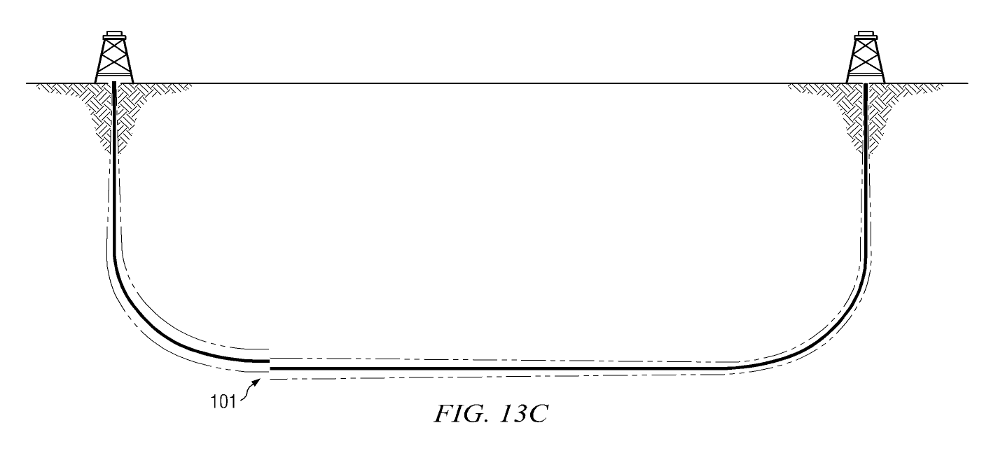

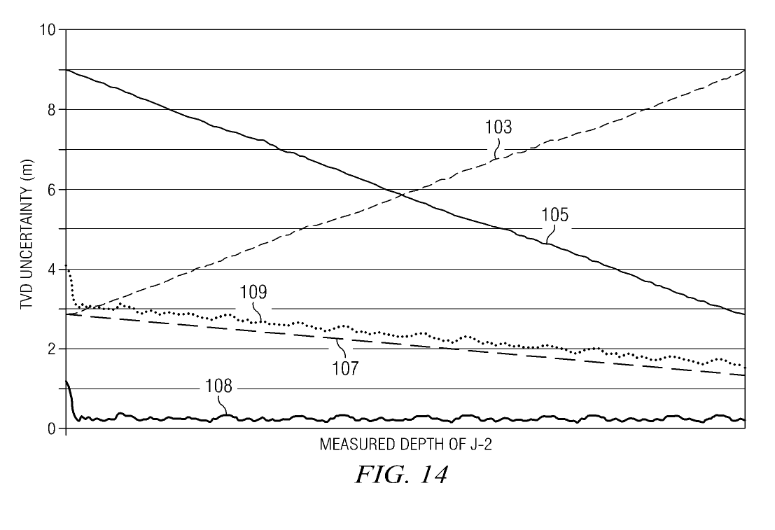

Still another aspect of the present invention is described with respect to FIGS. 13 and 14. In conventional SAGD operations a twin well is drilled in the same direction (and substantially parallel with) a target well (typically from the same pad). The determination of relative and combined error models for such an operation is described above with respect to FIGS. 1-9. FIG. 13A depicts an alternative twinning scenario in which the twin well J-2 is landed at or near the distal end of the target well J-1 and then drilled along the horizontal section of the target well in the opposite direction of the target J-1 (the horizontal section of J-1 is drilled to the left while the horizontal section of J-2 is drilled to the right in the schematic illustration of FIG. 13A). By landed it is meant that the inclination of the twin well J-2 builds to near horizontal at or near the end of the target well J-1. The “landing point” 101 is within sensory range (e.g., magnetic sensory range) of the target well J-1 and may also be referred to herein as an intercept or an intercept point (landing point 101 is somewhat analogous to intercept point 89 depicted on FIGS. 11A-11C). By opposite direction it is meant that the twin well is “drilled up” the target well such that the azimuth of the horizontal section of the twin well is offset from that of the target by about 180 degrees.

FIG. 13B depicts conventional absolute uncertainties for each of the J-shaped wells J-1 and J-2 up to the landing point 101. These standard errors may be computed, for example, using conventional Wolff and DeWardt and/or ISCWSA methodologies. As described above with respect to FIG. 11B (and as depicted), the resulting standard errors may be represented by cones of uncertainty in which the uncertainty increases monotonically with increasing measured depth of the wells. Owing to the different well paths, the absolute uncertainty of the J-2 well is significantly less than the absolute uncertainty of the J-1 well at the landing 101.

With reference now to FIG. 13C (and as described above with respect to FIG. 11C) the absolute uncertainty of the twin well J-2 may be used in an alternative determination of the absolute uncertainty of the target well J-1 at the landing point 101. In this sense, the twin well J-2 may be thought of as being functionally equivalent with the vertical pilot well described above with respect to FIGS. 11A-11C. Following the development discussed above, the computed position and absolute uncertainty of the twin J-2 may be used to reduce the absolute positional uncertainty (error) of the target J-1. The absolute uncertainty of the target J-1 may then be recalculated along its path retrospectively back up the surface as depicted. This results in a significant reduction in uncertainty as compared to the uncertainty obtained using conventional error models. Drilling of the twin well J-2 continues along the horizontal section of the target well J-1 using the above described relative positioning techniques. The relative uncertainty between the twin J-2 and the target J-1 may be calculated as described above with respect to FIGS. 1-7.

FIG. 14 depicts a plot of TVD error as a function of the measured depth of the twin well J-2 for the example described above with respect to FIGS. 13A-13C (as stated above with respect to FIG. 12 other error dimensions may also be considered). Conventional absolute uncertainties for the twin J-2 and target J-1 wells are depicted at 103 and 105. The combined absolute uncertainty for the target well J-1 is depicted at 107. A relative uncertainty between the twin J-2 and target J-1 wells is depicted at 108. A further combined absolute uncertainty of the twin well J-1 is depicted at 109. FIG. 14 depicts the dramatic decrease in the absolute uncertainties of both the twin J-2 and target J-1 wells.

It will be understood that the invention is not limited merely to SAGD or well twinning applications. On the contrary, methods in accordance with the present invention may be advantageously utilized in a wide range of well drilling applications. For example, combined error models may be advantageously utilized in shallow angle interceptions such as relief well drilling and well avoidance operations and in vertical to horizontal intersections such as pilot wells and coal bed methane intercepts. The invention may also be utilized in surface to surface or surface to near surface operations such as platform to platform, sub-sea to sub-sea, and river crossing operations. The invention may also be advantageously utilized in substantially any multi-well environment and may be suitable for remodeling a previously existing reservoir using known intercept points. Such remodeling may advantageously improve the positional certainty of existing wells and reduce the likelihood of collisions.

It will also be appreciated that the invention is not limited to the intercept between two or more wells. For example, the positional certainty of formation boundaries, liquid contacts, faults, and other known geophysical structures may be applied to a well based on MWD, LWD, wireline, or other measurements of the relative position between a well and such structures.

The invention is now described in further detail with respect to the flowchart depicted on FIG. 15 and the examples described above with respect to FIGS. 11A-11C and FIGS. 13A-13C. The example depicted on FIG. 11A includes two well paths: a first that is predominantly vertical (pilot well 82) and a second that is predominantly horizontal (the horizontal section of J-shaped well 86). The example depicted on FIG. 13A likewise depicts two well paths: a first J-shaped well J-1 and a second J-shaped well J-2 “drilled up” the first well J-1. In each of these examples, the two wells have markedly different absolute uncertainties at the intercepts 89 and 101 due to the different well paths (and measured depths). The flowchart of FIG. 15 depicts an example in which at least one location within a first well Wa is within sensory range (or intercepts) at least one location in a second well Wb. At the “intercept”, the nominal locations of each of the two wells, La and Lb, may be determined using conventional survey measurements. The absolute uncertainties Ua and Ub in the positions La and Lb may be determined using the prior art absolute error models referenced above. In this example, it is assumed that Ua <<Ub, although the invention is not limited in this regard.

The relative separation between the two wells may be measured, for example, using inter-well ranging techniques and is represented as Lr. The relative uncertainty in this determination, Ur, may be obtained, for example, as described above with respect to FIGS. 1-7. In general, Ur is also significantly less than Ub (represented herein as Ur<<Ub), although the invention is again not limited in this regard. The location Lb may be determined alternatively from La and Lr (e.g., via vector addition) such that Lb2=La+Lr. Moreover, the uncertainty of the alternatively calculated location Lb2 may be determined by combining Ua and Ur. This alternatively calculated absolute uncertainty, Ub2, is also typically much less than Ub (Ub2<<Ub) since both Ua and Ur are typically much less than Ub.

In considering this hypothetical example, it will be realized that the surveys used to determine the above referenced positions typically include a set of survey measurements (with each survey measurement including a measured depth, a borehole inclination, and a borehole azimuth) and that the uncertainties, following the prior art procedures, are determined assuming a model where each of these measurements are contaminated by a set of unknown but substantially constant systematic errors of some maximum value. With reference now to FIG. 15, the position of the entire well path Wb of the second well may be corrected and the uncertainty in that position reduced via the use of the first well Wa.

At 202 standard surveying methods and prior art error models (e.g., Wolff and DeWardt) may be utilized to determine the locations La and Lb and their corresponding absolute uncertainties Ua and Ub. These surveying methodologies may include substantially any wireline and/or MWD measurements and may further include various known refinements such as multi-station analysis. At 204 inter-well ranging measurements are utilized to determine the relative separation between the two wells Lr (at some point at which the two wells Wa and Wb are within sensory range of one another) and the corresponding relative uncertainty in that separation Ur. These inter-well ranging measurements may include, for example, various active and/or passive ranging methodologies (e.g., as described in commonly assigned U.S. Pat. Nos. 7,617,049 and 7,656,161). The relative uncertainty Ur may be determined, for example, via the methodology described above with respect to FIGS. 2-7.

At 206, an alternative location Lb2 is determined via combining La and Lr (for example, via three-dimensional vector addition). The alternative location Lb2 is not typically the same as previously determined location Lb. At 208, an alternative uncertainty Ub2 is determined via combining Ua and Ur as described above with respect to FIG. 8. Ub2 is also typically significantly less than Ub (since Ua and Ur are each significantly less than Ub). Step 208 may further include ascertaining that Ub2 is indeed less than Ub.

At 210, an overlap (e.g., an overlap volume) Ub3 between uncertainties Ub and Ub2 is determined (the overlap is not necessarily a three dimensional volume). If the uncertainties Ub and Ub2 do not overlap, this may be taken as a likely signal that there is error in at least one of the preceding steps. An expected location Lb3 may then be selected at 212 such that Lb3 is within (e.g., centered in) the overlap Ub3. In typical embodiments in which Ub2<<Ub, the volume of uncertainty Ub2 is commonly fully located within Ub such that the overlap Ub3 is equal to Ub2. In such embodiments, the expected location Lh3 may be taken to be equal to Lh2, although the invention is not limited in this regard.

In 214 the original survey measurements for well Wb are corrected by determining a set of constant systematic errors as used by the adopted error model so as to determine an improved set of survey measurements. In particular, a systematic error may be determined in the original Wb survey measurements (e.g., the measured depth, borehole inclination, and borehole azimuth values that were used to determined Lb in 202) such that a resultant location Lb4 equals Lb3. The survey set, with corrections applied, form the new definitive well path for the well Wb. It is typically necessary to then ascertain that the systematic errors determined are within expected error tolerances and to consider the bias values so determined as a correction of recalibrations of the existing sensors used in Wb. In 216 the original systematic errors used to determine Ub in 202 may also be modified such that a newly computed absolute uncertainty Ub4 equals the uncertainty Ub3 (overlap Ub3). The new systematic errors (also referred to herein as modified parameters) may be determined, for example, via analytical methods or numerical techniques. The invention is not limited in this regard.

In 218, the corrected survey measurements, determined in 214, and the corrected systematic errors, determined in 216, may be applied retroactively to other locations in Wb to obtain a better estimate of the well path and an improved (lower volume) cone of uncertainty (e.g., as depicted on FIGS. 11C and 13C).

While exemplary aspects of the invention are described above with respect to embodiments in which the uncertainty of one well is significantly less than that of another, it will be understood the invention is not limited in this regard. In general it may be desirable to incorporate other independent measurements to improve the certainty (decrease the uncertainty) of a well. When any two wells intersect (i.e., are within sensory range of one another) it may be possible to reduce the uncertainty of either or both wells by considering the error of both and the relative positional measurement between the two. This reduction is possible (depending on the operational details) since there are now a plurality of independent measurements (e.g., surveys) defining the location of the intercept.

In another application, it may be possible to determine a geological (or stratigraphic) position for well Wb. For example, if well Wb passes close to well Wa with the TVD of the identified stratigraphic marker well know, it may be possible to use the TVD from well Wa even when the wells Wa and Wb are not within sensory range of one another. This may allow the TVD error to be corrected in such a matter as to allow the TVD throughout well Wb to be better defined. Such improvement may be useful, for example, in reservoir modeling.

It will be understood that aspects and features of the present invention may be embodied as logic that may be processed by, for example, a computer, a microprocessor, hardware, firmware, programmable circuitry, or any other processing device well known in the art. Similarly the logic may be embodied on software suitable to be executed by a computer processor, as is also well known in the art. The invention is not limited in this regard. The software, firmware, and/or processing device is typically located at the surface (although the invention is not limited in this regard) and configured to process data sent to the surface by sensor sets via a telemetry or data link system also well known in the art. Electronic information such as logic, software, or measured or processed data may be stored in memory (volatile or non-volatile), or on conventional electronic data storage devices such as are well known in the art.

Although the present invention and its advantages have been described in detail, it should be understood that various changes, substitutions and alternations can be made herein without departing from the spirit and scope of the invention as defined by the appended claims.

We claim:

1. A method for determining a relative uncertainty between a first location on a first well and a corresponding second location on a second well, the method comprising:
(a) acquiring inter-well ranging data;
(b) causing a processor to process the ranging data acquired in (a) to obtain a separation between the first and second locations; and
(c) causing the processor to process at least one of the separation obtained in (b) and the ranging data acquired in (a) to obtain the relative uncertainty between the first and second locations.

2. The method of claim 1, wherein the relative uncertainty obtained in (c) is a relative uncertainty in a distance between the first location and the second location.

3. The method of claim 1, wherein the relative uncertainty obtained in (c) comprises a two-dimensional relative uncertainty or a three dimensional relative uncertainty.

4. The method of claim 3, wherein:
the two-dimensional uncertainty is an uncertainty ellipse; and
the three-dimensional uncertainty is an uncertainty ellipsoid.

5. The method of claim 3, wherein the two dimensional uncertainty comprises plan and sectional dimensions.

6. The method of claim 3, wherein:
the two dimensional uncertainty comprises radial distance and tangential dimensions; and
the three dimensional uncertainty comprises a radial distance dimension, a tangential dimension, and a third dimension of uncertainty.

7. The method of claim 3, wherein the first well is a target well and the second well is a twin well, the method further comprising:
(d) repeating (a), (b) and (c) at a plurality of other locations in the twin well.

8. The method of claim 1, wherein the inter-well ranging data comprises magnetic ranging data.

9. The method of claim 1, wherein the separation obtained in (b) comprises a two-dimensional vector or a three-dimensional vector.

10. The method of claim 1, wherein (c) further comprises causing the processor to process the separation obtained in (b) in combination with a relative error model relating the relative uncertainty to the separation.

11. The method of claim 1, wherein: (c) further comprises causing the processor to process the separation obtained in (b) in combination with (i) a first relative error model relating a first relative uncertainty parameter to the separation and (ii) a second relative error model relating a second relative uncertainty parameter to the separation.

12. The method of claim 11, wherein the first relative uncertainty parameter is a distance uncertainty and the second relative uncertainty is a tool face to target uncertainty.

13. The method of claim 1, further comprising:
(d) causing the processor to process the relative uncertainty obtained in (c) to determine a direction of subsequent drilling of one of the wells.

14. A method of well planning comprising:
(a) acquiring a relative error model that relates an uncertainty in a relative position on a first well with respect to a second well;
(b) computing a relative uncertainty of the position on the first well with respect to the second well using the relative error model acquired in (a) and a predetermined separation between the first well and the second well; and
(c) using the error model acquired in (a) and the uncertainty computed in (b) to plan a well path for the first well with respect to the second well.

15. A method for determining an absolute uncertainty of at least one location on a well, the method comprising:
(a) acquiring an absolute uncertainty of a first location on a first well;
(b) computing a relative uncertainty of a second location on a second well with respect to the first location on the first well, the second location being within sensory range of the first location; and
(c) combining the absolute uncertainty of the first location on the first well acquired in (a) with the relative uncertainty of the second location on the second well computed in (b) to obtain an absolute uncertainty of the second location on the second well.

16. The method of claim 15, wherein the first well is a target well and the second well is a twin well and the method further comprises:
(d) repeating (a), (b), and (c) at a plurality of corresponding first and second locations on the target and twin wells to obtain a plurality of absolute uncertainties.

17. The method of claim 16, further comprising:
(e) repeating (a), (b), (c), and (d) for a second twin well and target well pair; and
(f) comparing the relative locations and absolute uncertainties of the first and second twin and target well pairs.

18. The method of claim 15, wherein (c) further comprises:
(i) applying the absolute uncertainty of the first location acquired in (a) to the second location; and
(ii) adding the relative uncertainty computed in (b) to the absolute uncertainty applied to the second location in (i) to obtain the absolute uncertainty of the second location.

19. The method of claim 15, wherein (b) further comprises:
(i) acquiring inter-well ranging data;
(ii) causing a processor to process the ranging data acquired in (i) to obtain a separation between the first location the second location; and
(iii) causing the processor to process at least one of the separation obtained in (ii) and the ranging data acquired in (i) to obtain the relative uncertainty.

20. The method of claim 19, wherein: (iii) further comprises causing the processor to process the separation obtained in (ii) in combination with a first relative error model relating a first uncertainty parameter to the separation and a second relative error model relating a second uncertainty parameter to the separation.

21. A method for determining an absolute uncertainty in a second well path, the method comprising:
(a) acquiring absolute uncertainties of at least a first location on a first well and at least a second location on a second well using an absolute error model, the first and second locations being within sensory range of one another;
(b) computing a relative uncertainty between the first location and the second location using a relative error model;
(c) computing modified parameters for the absolute error model used to acquire the absolute uncertainties in (a) from the absolute uncertainty of the first location acquired in (a) and the relative uncertainty computed in (b);
(d) computing absolute uncertainties at selected other locations on the second well using the modified parameters computed in (c).

22. The method of claim 21, wherein (b) further comprises:
(i) acquiring inter-well ranging data at one of the first and second locations;
(ii) causing a processor to process the ranging data acquired in (i) to obtain a separation between the first location and the second location; and
(iii) causing the processor to process at least one of the separation obtained in
(ii) and the ranging data acquired in (i) to obtain the relative uncertainty.

23. The method of claim 21, wherein (c) further comprises:
(i) computing an alternatively derived absolute uncertainty of the second location using the absolute uncertainty of the first location acquired in (a) and the relative uncertainty obtained in (b);
(ii) computing the modified parameters from the alternatively derived absolute uncertainty computed in (i).

24. The method of claim 21, wherein (c) further comprises:
(i) computing an alternatively derived absolute uncertainty of the second location using the absolute uncertainty of the first location acquired in (a) and the relative uncertainty obtained in (b);
(ii) determining an overlap between the absolute uncertainty of the second location acquired in (a) and the alternatively derived absolute uncertainty computed in (i); and
(iii) selecting the modified parameters so that the error model used in (a) generates an absolute uncertainty at the second location substantially equal to the overlap determined in (ii).

25. The method of claim 21, wherein (c) further comprises
(i) computing an alternatively derived second location and an absolute uncertainty of the alternatively derived second location using the absolute uncertainty of the first location acquired in (a) and the relative uncertainty obtained in (b);
(ii) determining an overlap between the absolute uncertainty of the second location acquired in (a) and the alternatively derived absolute uncertainty computed in (i); and
(iii) selecting an expected second location within the overlap determined in (ii);
(iv) processing the expected second location to obtain corrected survey measurements for the second well path; and
(v) selecting the modified parameters so that the error model used in (a) generates an absolute uncertainty at the second location substantially equal to the overlap determined in (ii).

26. The method of claim 25, wherein the alternatively derived second location computed in (i) is substantially the same as the expected second location in (iii).

27. The method of claim 21, wherein the selected other locations on the second well have a measured depth less than that of the second location.

28. The method of claim 21, wherein the selected other locations on the second well have a measured depth greater than that of the second location.

29. A method for determining an absolute uncertainty of at least one location on a well path, the method comprising:
(a) drilling first and second wells to within sensory range of one another;
(b) measuring a separation between at least a first location on the first well and at least a second location on the second well;
(c) computing a relative uncertainty in the separation;
(d) computing absolute uncertainties of at least the first and second locations using an absolute error model;
(e) combining the absolute uncertainty of the first location computed in (d) with the relative uncertainty computed in (c) to obtain an alternative absolute uncertainty of the second location.

30. The method of claim 29, wherein the first well is a substantially vertical pilot well and the second well is a substantially J-shaped well.

31. The method of claim 29, wherein the first well is a target well and the second well is a twin well drilled in a substantially opposite direction as the target well.

32. The method of claim 29, wherein the alternative absolute uncertainty of the second location obtained in (e) is less than the absolute uncertainty of the second location computed in (d).

33. The method of claim 29, further comprising:
(f) determining an overlap between the absolute uncertainty of the second location computed in (d) and the alternative absolute uncertainty obtained in (e).

34. The method of claim 33, wherein the overlap determined in (0 is substantially equal to the alternative absolute uncertainty obtained in (e).

35. The method of claim 33, further comprising:
(g) computing modified parameters for the absolute error model used in (d) so that the error model generates an absolute uncertainty substantially equal to the overlap determined in (f).

36. The method of claim 35, further comprising:
(h) using the modified parameters computed in (g) to compute an absolute uncertainty at selected other locations on the second well.

37. A method for determining an absolute uncertainty of a well, the method comprising:
(a) sensing one well from another well;
(b) transferring an absolute uncertainty of one of the wells to the other of the wells; and
(c) recalculating an absolute uncertainty of at least one of the wells using the absolute uncertainty of the other of the wells.
